(19) United States
(12) Patent Application Publication
(10) Pub. No.: US 2024/0354657 A1
(43) Pub. Date: Oct. 24, 2024

(54) METHOD AND APPARATUS FOR DIGITAL TWIN VIRTUAL-REALITY SYNCHRONIZATION MAPPING OF MECHANICAL ARM

(71) Applicant: ZHENGZHOU UNIVERSITY OF LIGHT INDUSTRY, Zhengzhou (CN)

(72) Inventors: Hao LI, Zhengzhou (CN); Gen LIU, Zhengzhou (CN); Xingyou HE, Zhengzhou (CN); Haoqi WANG, Zhengzhou (CN); Linli LI, Zhengzhou (CN); Xiaoyu WEN, Zhengzhou (CN); Shizhong WEI, Zhengzhou (CN); Yuyan ZHANG, Zhengzhou (CN); Weifei GUO, Zhengzhou (CN); Wenchao YANG, Zhengzhou (CN)

(73) Assignee: ZHENGZHOU UNIVERSITY OF LIGHT INDUSTRY, Zhengzhou (CN)

(21) Appl. No.: 18/739,779

(22) Filed: Jun. 11, 2024

(30) Foreign Application Priority Data
Apr. 22, 2023 (CN) 202410481024.7

(51) Int. Cl. G06N 20/00

(52) U.S. Cl. CPC G06N 20/00

(57) ABSTRACT

A method for digital twin virtual-reality synchronization mapping of a mechanical arm comprises acquiring a virtual mechanical arm model built based on an actual mechanical arm in a virtual environment, where the virtual mechanical arm model is configured to map the actual mechanical arm; acquiring real motion information collected when the actual mechanical arm moves; constructing a training set and a test set based on the real motion information; training a target multilayer perceptron model based on the training set, and testing the target multilayer perceptron model based on the test set, where the target multilayer perceptron model is configured to predict a motion of the virtual mechanical arm model in the virtual environment; and deploying the target multilayer perceptron model on the actual mechanical arm when the target multilayer perceptron model meets a preset condition. According to this method, operation accuracy and efficiency of the mechanical arm are improved.

### CROSS-REFERENCE TO RELATED APPLICATIONS

This application claims priority to Chinese Patent Application No. 202410481024.7 with a filing date of Apr. 22, 2024. The content of the aforementioned application, including any intervening amendments thereto, is incorporated herein by reference.

### TECHNICAL FIELD

The present application relates to the technical field of artificial intelligence and digital twin, and in particular, to a method and apparatus for digital twin virtual-reality synchronization mapping of a mechanical arm.

### BACKGROUND

A digital twin technology is a way to map physical entities into digitized virtual objects. The technology represents and simulates real behavior of the physical entities in a virtual environment, aiming at optimizing and enhancing capabilities of the physical entities through virtual-real interactive feedback, data fusion analysis, and decision support, and extending the capabilities to new fields.

Currently, the digital twin technology mainly involves the following aspects: The digital twin technology can model and simulate entity objects or systems with high precision by using various sensor data, real-time data acquisition and analysis technologies, and advanced simulation software. These models may be based on physical principles or data-driven, depending on application scenarios and requirements. In addition, the digital twin technology further allows real-time monitoring and control of a state and behavior of entity objects or systems. By keeping synchronization with physical objects or systems in the real world, the digital twin technology can provide timely feedback information, thereby enabling an operator or a control system to adjust and optimize operational policies in real time. Based on a digital twin model, various predictions and optimization analysis can be performed. Through simulation and experiments of the model, behavior of the entity objects or systems under different conditions can be predicted, so as to optimize their design, operation and maintenance policies to improve efficiency, reduce costs or improve performance.

Gradient descent is an optimization algorithm, which is used to minimize a value of a function. Compared with other optimization methods, the gradient descent method has the advantages of simplicity, high efficiency, universality, and the like, and is excellent in solving various optimization problems. Therefore, the gradient descent is widely used in scientific computing, machine learning, deep learning, and other fields.

Virtual-reality synchronization is an important technical concept, which implements synchronization of time, action or data between a virtual environment and a real environment to ensure consistency and coordination therebetween. In this case, behavior of a mechanical arm is synchronized with a simulation model in the virtual environment by means of the digital twin technology, so as to implement a more accurate and controllable operation. Overall, the development of virtual-reality synchronization technology can not only improve efficiency and effects of training and operation, but also expand the scope of application and potential of virtual reality, industrial manufacturing and other fields, bringing new opportunities and challenges to the development and progress of human society.

However, in the prior art, if there is no real-time data transmission between an actual mechanical arm and a virtual mechanical arm, real-time high-precision synchronization cannot be implemented, and operation accuracy and efficiency of the mechanical arm are low.

### SUMMARY OF PRESENT INVENTION

Embodiments of the present application provide a method and apparatus for digital twin virtual-reality synchronization mapping of a mechanical arm, which can improve operation accuracy and efficiency of the mechanical arm.

In a first aspect, a method for digital twin virtual-reality synchronization mapping of a mechanical arm according to the present application includes:
acquiring a virtual mechanical arm model built based on an actual mechanical arm in a virtual environment, where the virtual mechanical arm model is configured to map the actual mechanical arm;
acquiring real motion information collected when the actual mechanical arm moves;
constructing a training set and a test set based on the real motion information;
training a target multilayer perceptron model based on the training set, and testing the target multilayer perceptron model based on the test set, where the target multilayer perceptron model is configured to predict a motion of the virtual mechanical arm model in the virtual environment; and
deploying the target multilayer perceptron model on the actual mechanical arm when the target multilayer perceptron model meets a preset condition.

In a second aspect, an apparatus for digital twin virtual-reality synchronization mapping of a mechanical arm according to the present application includes:
an acquisition module, configured to acquire a virtual mechanical arm model built based on an actual mechanical arm in a virtual environment, where the virtual mechanical arm model is configured to map the actual mechanical arm;
a motion acquisition module, configured to acquire real motion information collected when the actual mechanical arm moves;
a construction module, configured to construct a training set and a test set based on the real motion information;
a model training module, configured to train a target multilayer perceptron model based on the training set, and test the target multilayer perceptron model based on the test set, where the target multilayer perceptron model is configured to predict a motion of the virtual mechanical arm model in the virtual environment; and
a model deployment module, configured to deploy the target multilayer perceptron model on the actual mechanical arm when the target multilayer perceptron model meets a preset condition.

In a third aspect, an electronic device according to the present application includes a memory and a processor, where the memory stores a computer program, and the processor is configured to run the computer program in the memory to implement the steps in the method for digital twin virtual-reality synchronization mapping of a mechanical arm according to the present application.

In a fourth aspect, a computer-readable storage medium according to the present application stores a plurality of instructions, where the instructions are suitable for being loaded on a processor, to implement the steps in the method for digital twin virtual-reality synchronization mapping of a mechanical arm according to the present application.

In a fifth aspect, a computer program product according to the present application includes a computer program or instructions, where the computer program or instructions, when executed by a processor, implement the steps in the method for digital twin virtual-reality synchronization mapping of a mechanical arm according to the present application.

In the present application, compared with related technologies, a virtual mechanical arm model built based on an actual mechanical arm in a virtual environment is acquired, where the virtual mechanical arm model is configured to map the actual mechanical arm; real motion information collected when the actual mechanical arm moves is acquired; a training set and a test set are constructed based on the real motion information; a target multilayer perceptron model is trained based on the training set, and the target multilayer perceptron model is tested based on the test set, where the target multilayer perceptron model is configured to predict a motion of the virtual mechanical arm model in the virtual environment; and the target multilayer perceptron model is deployed on the actual mechanical arm when the target multilayer perceptron model meets a preset condition. According to the present application, a digital twin model of the mechanical arm is constructed, and high-precision synchronization between the virtual environment and a real environment is implemented by using a neural network, so that real-time synchronization can be implemented even if there is no real-time data transmission between the actual mechanical arm and the virtual mechanical arm during motion. By means of a self-learning ability of the neural network, synchronization mapping between the virtual mechanical arm and the actual mechanical arm is implemented, so that operation accuracy of the mechanical arm can be improved, and fault simulation, performance test and operation training can be performed in the virtual environment. Therefore, an operation policy is optimized and production efficiency is improved without actually running the mechanical arm.

### BRIEF DESCRIPTION OF THE DRAWINGS

To describe the technical solutions in the embodiments of the present application more clearly, the accompanying drawings required to describe the embodiments are briefly described below. Apparently, the accompanying drawings described below are only some embodiments of the present application. Those skilled in the art may further obtain other accompanying drawings based on these accompanying drawings without creative efforts.

FIG. 1 is a schematic diagram of a scenario of a system for digital twin virtual-reality synchronization mapping of a mechanical arm according to an embodiment of the present application;

FIG. 2 is a schematic flowchart of a method for digital twin virtual-reality synchronization mapping of a mechanical arm according to an embodiment of the present application;

FIG. 3 is a schematic flowchart showing construction of a virtual mechanical arm model in a method for digital twin virtual-reality synchronization mapping of a mechanical arm according to an embodiment of the present application;

FIG. 4 is a schematic flowchart showing training of a target multilayer perceptron model in a method for digital twin virtual-reality synchronization mapping of a mechanical arm according to an embodiment of the present application;

FIG. 5 is a schematic structural diagram of an apparatus for digital twin virtual-reality synchronization mapping of a mechanical arm according to an embodiment of the present application; and

FIG. 6 is a schematic structural diagram of an electronic device according to an embodiment of the present application.

### DETAILED DESCRIPTION OF THE EMBODIMENTS

It should be noted that the principle of the present application is illustrated by being implemented in an appropriate computing environment. The following description is based on the illustrated specific embodiments of the present application, and should not be considered as limiting other specific embodiments of the present application not detailed herein.

Unless otherwise defined, all technical and scientific terms used herein have the same meaning as commonly understood by those skilled in the technical field of the present application. The terms mentioned herein are used merely to describe the embodiments of the present application, rather than to limit the present application.

In order to improve effects of virtual-reality synchronization mapping of a mechanical arm, embodiments of the present application provide a method for digital twin virtual-reality synchronization mapping of a mechanical arm and an apparatus for digital twin virtual-reality synchronization mapping of a mechanical arm. The method for digital twin virtual-reality synchronization mapping of a mechanical arm may be performed by the apparatus for digital twin virtual-reality synchronization mapping of a mechanical arm, or by an electronic device integrated with the apparatus for digital twin virtual-reality synchronization mapping of a mechanical arm.

The technical solutions in the embodiments of the present application are clearly and completely described below with reference to the accompanying drawings in the embodiments of the present application. Apparently, the described embodiments are only some rather than all of the embodiments of the present application. All other embodiments obtained by those skilled in the art based on the embodiments of the present application without involving any creative effort shall fall within the scope of protection of the present application.

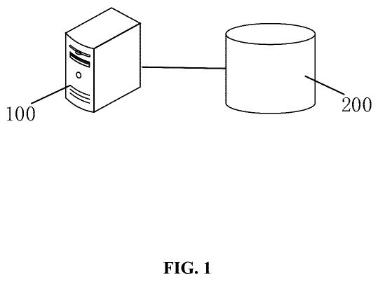

Referring to FIG. 1, the present application further provides a system for digital twin virtual-reality synchronization mapping of a mechanical arm. As shown in FIG. 1, the system for digital twin virtual-reality synchronization mapping of a mechanical arm includes an electronic device 100, and an apparatus for digital twin virtual-reality synchronization mapping of a mechanical arm according to the present application is integrated in the electronic device 100.

The electronic device 100 may be any device equipped with a processor and thus capable of processing, for example, a mobile electronic device with a processor, such as a smartphone, a tablet computer, a palmtop computer, a notebook computer, and a smart speaker, or a fixed electronic device with a processor, such as a desktop computer, a television, a server, and an industrial device.

In addition, as shown in FIG. 1, the system for digital twin virtual-reality synchronization mapping of a mechanical arm may further include a memory 200 configured to store original data, intermediate data, and result data.

In the embodiment of the present application, the memory 200 may be a cloud storage, and the cloud storage is a new concept extended and developed from the concept of cloud computing. A distributed cloud storage system (hereinafter referred to as storage system) refers to a storage system that assembles, by means of functions such as cluster application, a grid technology, and a distributed storage file system, a large number of different types of storage devices (storage devices also referred to as storage nodes) in the network via application software or application interfaces, to cooperatively operate to jointly provide data storage and service access functions.

Currently, a storage method of the storage system is to create logical volumes. During creation of the logical volumes, physical storage space is allocated to each logical volume. The physical storage space may be composed of disks of a storage device or several storage devices. A client stores data on a logical volume, that is, the client stores the data on a file system. The file system divides the data into many parts, and each part is an object. The object not only contains data but also contains additional information such as data identity (ID). The file system writes each object into the physical storage space of the logical volume, and the file system records storage location information of each object, so that when the client requests to access the data, the file system can allow the client to access the data based on the storage location information of each object.

The process of allocating physical storage space for each logical volume by the storage system is specifically as follows: Based on estimation of a capacity of objects stored in the logical volume (the estimation often has a large margin relative to the actual capacity of objects to be stored) and the group of redundant array of independent disks (RAID), the physical storage space is divided into stripes in advance, and a logical volume may be understood as a stripe, so that the physical storage space is allocated for the logical volume.

It should be noted that the schematic diagram of the scenario of the system for digital twin virtual-reality synchronization mapping of a mechanical arm shown in FIG. 1 is only an example. The system for digital twin virtual-reality synchronization mapping of a mechanical arm and the scenario described in the embodiment of the present application are intended to describe the technical solutions according to the embodiment of the present application more clearly, but are not intended to constitute a limitation on the technical solutions according to the embodiment of the present application. As is known by those of ordinary skill in the art, with the evolution of the system for digital twin virtual-reality synchronization mapping of a mechanical arm and the emergence of new service scenarios, the technical solutions according to the embodiment of the present application are also applicable to similar technical problems.

Detailed descriptions are provided below. It should be noted that the serial numbers of the following embodiments are not used as a limitation on a preferred order of the embodiments.

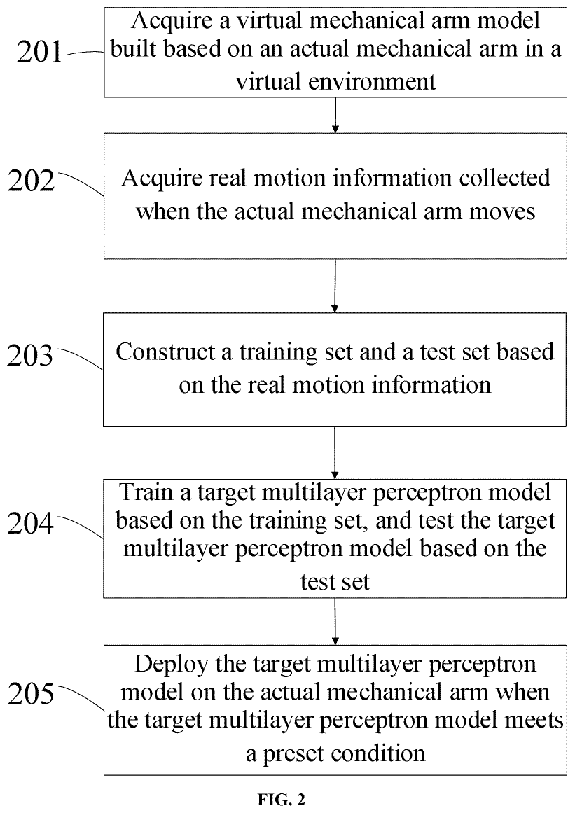

FIG. 2 is a schematic flowchart of a method for digital twin virtual-reality synchronization mapping of a mechanical arm according to an embodiment of the present application. As shown in FIG. 2, the method for digital twin virtual-reality synchronization mapping of a mechanical arm according to the present application includes the following steps.

In step 201, a virtual mechanical arm model built based on an actual mechanical arm in a virtual environment is acquired.

The virtual mechanical arm model is configured to map the actual mechanical arm.

In the embodiment of the present application, the step that a virtual mechanical arm model built based on an actual mechanical arm in a virtual environment is acquired includes the following steps.

In step (1), an initial mechanical arm model obtained by mapping and modeling the actual mechanical arm is acquired.

In the embodiment of the present application, the actual mechanical arm is mapped and modeled to ensure accuracy of a digital twin model.

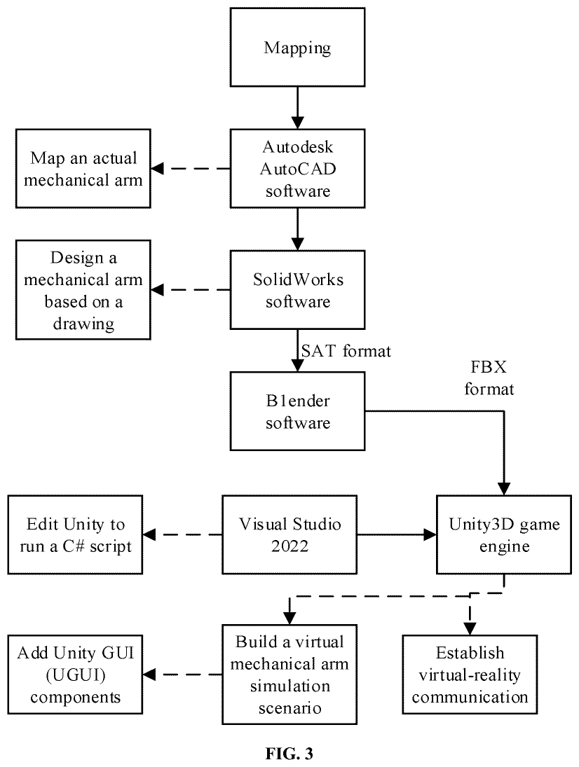

As shown in FIG. 3, the actual mechanical arm is mapped and modeled, which is mainly to ensure the accuracy of the digital twin model. The mapping mainly to accurately measure the actual mechanical arm by means of a vernier caliper, a protractor, and other tools. Then, Autodesk AutoCAD software is used to map the actual mechanical arm, and a drawing of each part is drawn based on measured data. After the drawing of the part drawing is completed, SolidWorks, three-dimensional modeling software, is used to accurately model at 1:1, and the mechanical arm is designed based on the drawing. The established model is exported to standard ACIS text (SAT) format. This format is conducive to the generation and segmentation of the model, and can easily control accuracy of the output, which facilitates subsequent model application and analysis.

In step (2), an origin of the initial mechanical arm model is set and a local coordinate system is adjusted.

As shown in FIG. 3, specifically, the origin of the initial mechanical arm model is set and the local coordinate system is adjusted. The origin of the model is set mainly to facilitate the assembly of the model when Unity 3D software is imported, and the local coordinate system is adjusted mainly to facilitate the correspondence of an actual angle of the mechanical arm to a virtual angle. By means of a Filmbox (FBX) format, a three-dimensional (3D) model can be imported from Blender into Unity 3D, since Unity 3D supports data such as animation, materials, and textures. Unity 3D has a built-in FBX importer, which simplifies the process of model import and editing. Default length units of the Unity software and the SolidWorks software are inconsistent and need to be scaled. A default unit of Unity is meter, while a default unit of SolidWorks is centimeter. In order to ensure an appropriate size of the model in Unity, the size of the SolidWorks model is enlarged by 100 times.

As shown in FIG. 3, after the model is imported into Blender, it is necessary to adjust the position of the origin and local coordinate system of each component to ensure accuracy and convenient operation of the component in the software. In addition, details of the model further need to be finely processed to achieve a desired visual effect and meet functional requirements. By means of the FBX file format, the 3D model is transferred from Blender to a Unity 3D game engine. FBX is a widely used 3D file format, which can be compatible with rich model data including animation, materials, and textures. Unity 3D provides native support for the FBX format. Thanks to the built-in FBX importer of Unity 3D, a user can easily import an FBX file for subsequent editing. This greatly simplifies the workflow. In a Unity 3D game development environment, a default world coordinate unit is meter, while the design is usually performed in a unit of centimeter when SolidWorks three-dimensional modeling software is used to construct each part model of the mechanical arm. This difference in unit system leads to a significant reduction in the size of the SolidWorks model directly imported into Unity 3D, so that it is difficult to effectively recognize and operate the model in a Unity game scenario. In order to solve this compatibility problem, the SolidWorks model is resized during the model migration. The specific operation is to enlarge the model size by 100 times along each axis, so as to ensure that the proportion and size of the model are appropriate in the Unity 3D environment, to facilitate observation and interaction with other game elements.

In step (3), the initial mechanical arm model is assembled based on a preset component set and a preset parent-child relationship to obtain the virtual mechanical arm model.

As shown in FIG. 3, during assembly of the virtual mechanical arm model, appropriate components are selected and the parent-child relationship is determined. Unity 3D provides a hinge joint component, which can simulate a motion of the mechanical arm or other mechanical structures with a plurality of rotating joints. By means of the hinge joint, all parts of the mechanical arm can be effectively connected, thus implementing motion simulation similar to the actual mechanical arm. In addition, for the control of the mechanical arm, setting up a parent-child relationship correctly is very crucial and is helpful to simplify writing of control code.

As shown in FIG. 3, in Unity 3D, during assembly of the part model in FBX format, the key is to pay attention to a parent-child relationship between parts and create an appropriate connection mechanism for each joint point of the mechanical arm when axes are connected. To this end, Unity 3D provides the hinge joint component, which can simulate a motion of the mechanical arm or other mechanical structures with a plurality of rotating joints. By means of the hinge joint, all parts of the mechanical arm can be effectively connected, thus implementing motion simulation similar to the actual mechanical arm. This method ensures functionality and realism of the mechanical arm model in a Unity scenario, and enables the mechanical arm model to operate and interact in a desired manner. After the virtual model is assembled, the virtual model is subjected to simple setting, such as selection and setting of mass and a rotation axis.

In the embodiment of the present application, the virtual mechanical arm model controls a motion via a control script, and the control script is controlled by means of a quaternion or a process identifier (PID). During writing of the control script and a communication script of the mechanical arm model, two different control schemes are used. The first scheme is to perform control by means of the quaternion. This method is simple and visual, and can directly control the rotation axis to reach a specified target position. Therefore, the control by means of the quaternion is mainly used in a training stage of the model. The second scheme is to perform control by means of a PID controller. This algorithm is suitable for an application scenario with a high requirement on precision control and system stability, and is usually used for a model that has been trained. For the communication script, the goal of the present application is to implement high-speed and low-delay data transmission and support multiple transport protocols. In order to meet these requirements, in the present application, it is chosen to perform data transmission in a wireless manner in a local area network. Such a communication mode can not only provide the required speed and delay characteristics, but also adapt to different transmission requirements, thereby ensuring flexibility and reliability of the system. As shown in FIG. 3, for an output file of the Unity 3D game engine, Visual Studio 2022 is used to edit Unity and run a C# script.

In the virtual model, according to the present application, a series of Unity GUI (UGUI) components are integrated to enhance user interaction experience and control functions. The components include:

Display of an angle of each axis: A current angle of each rotation axis of the mechanical arm is displayed in real time, and visual state information of the mechanical arm is provided for the user.

Switch button: The user is allowed to start or stop a motion of the mechanical arm by a simple tap operation, to conveniently and quickly control a running state of the mechanical arm.

Communication address input box: The user may input an address for data communication herein, so as to ensure that the mechanical arm can effectively exchange data with a control script or an external device.

Two control script switching buttons: An interface button is provided to enable the user to switch between control by means of a quaternion and control by means of a PID as required. The control by means of the quaternion is suitable for a model training stage, while the control by means of the PID is suitable for a trained model that needs precise control.

As shown in FIG. 3, the output file of the Unity 3D game engine is used to build a virtual mechanical arm simulation scenario, establish virtual communication, and add UGUI components.

In step 202, real motion information collected when the actual mechanical arm moves is acquired.

In the embodiment of the present application, the real motion information includes a real initial angle, a real current angle, and a real target angle.

In the embodiment of the present application, the step that real motion information collected when the actual mechanical arm moves is acquired includes the following steps.

In step (1), the real motion information of the actual mechanical arm during motion that is collected by a sensor according to a preset period is acquired.

Specifically, communication is performed via a socket interface to acquire the real motion information of the actual mechanical arm during motion that is collected by the sensor according to the preset period.

The preset period may be once every 20 ms, which may be set based on a specific situation. The real motion information includes a real initial angle, a real current angle, and a real target angle of the actual mechanical arm. Angle data of each axis of the actual mechanical arm is acquired mainly by the sensor, and collected every 20 ms, and then communicated via the socket interface.

In step (2), the real motion information is stored in a preset database.

The preset database may be MySQL, Oracle or another database that can store a large amount of data.

In order to train the mechanical arm, an initial position and a target position of the actual mechanical arm are randomly generated, and the actual mechanical arm is controlled to move from the initial position to the target position. During the movement of the actual mechanical arm from the initial position to the target position, real-time angle data is collected by the sensor at time intervals of 20 milliseconds. The real-time angle data is collected deliberately, and the collection starts from the initial position of an object and is kept until the mechanical arm moves to the predetermined target position. The collected angle data is stored in a database, and according to the present application, a MySQL database is designed to store the data.

In addition, data collection may be alternatively performed during motion of existing mechanical arms in factories. These factories usually adopt a conventional digital twin technology to implement virtual-reality synchronization mapping, that is, a virtual model is represented by an entity model or the entity model is controlled by the virtual model. The data collection is also performed by the sensor within a time interval of 20 milliseconds, and the collected data can be input into the database in real time. Different from deliberate collection of data, this data collection is an unplanned collection method.

In step 203, a training set and a test set are constructed based on the real motion information.

In the embodiment of the present application, the real motion information includes a plurality of pieces of sub-motion information, and the sub-motion information includes a real initial angle, a real current angle, and a real target angle. The step that a training set and a test set are constructed based on the real motion information includes the following step: The plurality of pieces of sub-motion information in the real motion information are placed into two sets to obtain the training set and the test set, where a quantity ratio of the sub-motion information in the training set and the test set is a preset ratio. The preset ratio may be 7:3. Of course, in another embodiment, the preset ratio may be a different value, which may be set based on a specific situation.

Specifically, each piece of sub-motion information in the real motion information is normalized, and the plurality of pieces of sub-motion information in the real motion information are placed into two sets to obtain the training set and the test set.

In step 204, a target multilayer perceptron model is trained based on the training set, and the target multilayer perceptron model is tested based on the test set.

The target multilayer perceptron model is configured to predict a motion of the virtual mechanical arm model in the virtual environment.

The target multilayer perceptron model includes an input layer, a hidden layer, and an output layer. The input layer is configured to normalize data, and the output layer is configured to output a group of vectors, which is linearly mapped to the model-predicted angle of the mechanical arm. With regard to the multilayer perceptron (MLP) model, an MLP is a feedforward artificial neural network, which is composed of at least three layers of nodes: an input layer, one or more hidden layers, and an output layer. The MLP uses a supervised learning technique referred to as backpropagation for training. The input layer of the multilayer perceptron has a size of 13, including a real initial angle initAngle, a real target angle expectAngle, and a number of steps.

There are three hidden layers in the target multilayer perceptron model, which have sizes of 128, 256 and 128 respectively. An input value (weighted sum plus bias) of each hidden layer node is calculated, and then transformed by a nonlinear activation function (such as Sigmoid and ReLU). z^{[l]} is a weighted sum of an l^{th} layer, wᵢ^{[l]} is a weight, aᵢ^{[l-1]} is an activation value of a (l−1)^{th} layer, b^{[l]} is a bias of the l^{th} layer, a^{[l]} is an activation value of the l^{th} layer, and f is an activation function. A formula is as follows:

$${z}^{[ l ]} = {\sum }_{i = 1}^{n} {w}_{i}^{[ l ]} {a}_{i}^{[ l - 1 ]} + {b}^{[ l ]}$$

$${a}^{[ l ]} = f ( {z}^{[ l ]} )$$

The output layer of the multilayer perceptron is connected to the hidden layer, and has a size of 6. The output layer contains an angle value of each axis at a current moment. In addition, the output layer uses a tanh activation function to scale an output content to [−1, 1]. The tanh formula is as follows:

$$tanh ( x ) = \frac{( {e}^{x} - {e}^{- x} )}{( {e}^{x} + {e}^{- x} )}$$

In the embodiment of the present application, the preset condition includes at least one of the following: a target loss value is less than a preset loss value and a number of iterations reaches a preset number of times. The step that a target multilayer perceptron model is trained based on the training set, and the target multilayer perceptron model is tested based on the test set includes the following steps.

In step (1), a real initial angle, a real target angle, and a number of steps in the training set are input into the target multilayer perceptron model to obtain a model-predicted angle.

Before training starts, it is necessary to normalize input data. The normalization can effectively accelerate convergence of a neural network. The normalization is implemented by means of the following formula:

$$input = [ \frac{initAngle}{180} , \frac{exceptAngle}{180} , steps ]$$

where input denotes a normalized model input, initAngle denotes the real initial angle, expectAngle denotes the real target angle, and is also a desired angle of the model, and steps denotes the number of steps.

The output layer is configured to output a group of vectors, which is linearly mapped to the model-predicted angle of the mechanical arm.

In step (2), the target loss value is calculated based on the model-predicted angle and a corresponding real current angle by using a preset loss function.

The preset loss function may be a mean square error (MSE). A loss function of the multilayer perceptron model is used to measure a difference between a mode-predicted value and a real value. The prediction of the mechanical arm is a regression problem, and the mean square error is used as the loss function for the regression problem.

A formula of the preset loss function is as follows:

$$MSE ( y , {y}^{′} ) = \frac{{\sum }_{i = 1}^{6} {( {y}_{i} - {y}_{i}^{′} )}^{2}}{n}$$

where yᵢ denotes an actual angle of the actual mechanical arm in an i^{th} sample, and y′ᵢ denotes a model-predicted angle corresponding to the actual angle of the i^{th} sample predicted by the neural network.

In step (3), the target multilayer perceptron model is iteratively updated until the target loss value is less than the preset loss value or the number of iterations reaches the preset number of times.

Specifically, a learning rate α is set to 0.001 to avoid instability of training caused by an excessive learning rate, and batchsize is set to 64.

In the embodiment of the present application, a gradient parameter of the target loss value relative to a current model parameter of the target multilayer perceptron model is calculated; the current model parameter of the target multilayer perceptron model is updated based on the gradient parameter and a preset learning rate to obtain an updated target multilayer perceptron model; and a new target loss value is determined based on the updated target multilayer perceptron model and a number of iterations is recorded once.

The current model parameter includes a weight and a bias. The backpropagation is used to calculate a gradient of the loss function with respect to each weight and bias. The backpropagation algorithm is a supervised learning algorithm for training an artificial neural network. The algorithm adjusts the weight and bias in the network by calculating an error between a network output and an actual target value, in order to minimize this error. A core of the backpropagation algorithm is gradient descent, which updates network parameters by calculating the gradient of the loss function with respect to these parameters. A formula is shown as follows:

$$\frac{\partial MSE}{\partial {w}_{i}^{[ l ]}} = \frac{\partial MSE}{\partial {a}^{[ l ]}} \cdot \frac{\partial {a}^{[ l ]}}{\partial {w}_{i}^{[ l ]}}$$

$$\frac{\partial MSE}{\partial {b}^{[ l ]}} = \frac{\partial MSE}{\partial {a}^{[ l ]}} \cdot \frac{\partial {a}^{[ l ]}}{\partial {b}_{i}^{[ l ]}}$$

where MSE denotes a target loss value, ∂ denotes taking a partial derivative, wᵢ^{[l]} denotes a weight, a^{[l]} is an activation value of the l^{th} layer, and b^{[l]} denotes a bias. The gradient descent algorithm updates the weight and the bias.

Gradient descent is an iterative algorithm for optimization problems, especially for minimizing a loss function in machine learning and deep learning. The gradient descent is a first-order optimization algorithm since it uses only gradient (that is, a first derivative of the loss function) information. The goal of the gradient descent is to find a value of a parameter and minimize the loss function. The gradient descent algorithm gradually adjusts the parameter in a negative direction of the loss function gradient until the parameter reaches a local minimum or a global minimum. A formula is shown as follows:

$${w}_{i}^{[ l ]} = {w}_{i - 1}^{[ l ]} - α \frac{\partial MSE}{\partial {w}_{i - 1}^{[ l ]}}$$

$${b}_{i}^{[ l ]} = {b}_{i - 1}^{[ l ]} - α \frac{\partial MSE}{\partial {b}_{i - 1}^{[ l ]}}$$

where α is a learning rate, wᵢ^{[l]} denotes a weight, b^{[l]} denotes a bias, and i denotes a number of iterations.

Then forward propagation, loss calculation, backpropagation, and parameter update are repeatedly performed until the model converges or a preset number of iterations is reached. Finally, the model is verified, and an independent data set is used to evaluate performance of the model. Prediction performance of the model may be denoted by a calculation method of MSE. A lower value calculated by means of the MSE indicates higher performance of the model; a higher value calculated by means of the MSE indicates lower performance of the model, and it is necessary to observe whether the loss value in training is normal, the setting of a hyper-parameter such as a learning rate, quality of data, and the like.

The training set is transmitted to the network as input data through the input layer, and is subjected to weighted summation in each layer, plus bias, and then nonlinear transformation is performed by means of an activation function. A loss of forward propagation and real data is calculated by means of the MSE, and then the gradient of each weight and bias is calculated by backpropagation. The weight and the bias are updated by means of the gradient descent algorithm. The operation is repeated until the performance of the model is no longer significantly improved or the preset number of iterations is reached. Finally, an independent test set is used to evaluate prediction performance of the model to ensure that the model has a good generalization ability. Angle data predicted by the model is compared with angle data of the actual mechanical arm to ensure consistency between the angle data on each axis.

Further, the preset condition includes that a model performance index meets a preset index condition. The step that a target multilayer perceptron model is trained based on the training set, and the target multilayer perceptron model is tested based on the test set includes the following step: When the target loss value is less than the preset loss value or the number of iterations reaches the preset number of times, the target multilayer perceptron model is tested based on the test set to obtain the model performance index of the target multilayer perceptron model on the test set.

The model performance index includes accuracy, recall, and the like.

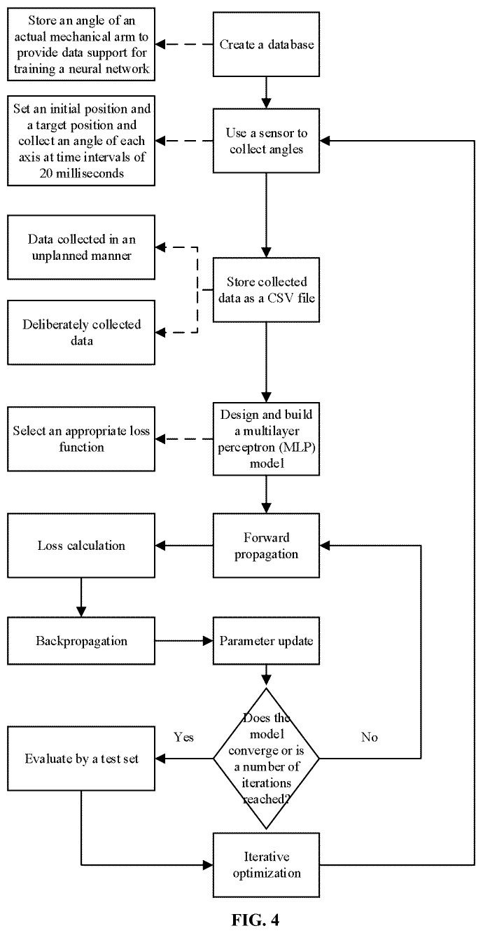

As shown in FIG. 4, a database is created, and a sensor is used to collect angle information. An angle of an actual mechanical arm is stored to provide data support for training a neural network. An initial position and a target position are set and an angle of each axis is collected at time intervals of 20 milliseconds. Collected data is stored as a comma-separated values (CSV) file. The data includes data collected in an unplanned manner and deliberately collected data. An MLP model is designed and built. An appropriate loss function is selected, and forward propagation, loss calculation, backpropagation, and parameter update are performed. It is determined whether the model converges or the number of iterations is reached. The test set is used for evaluation, iterative optimization is performed, and the sensor is reused to collect angle information.

In step 205, the target multilayer perceptron model is deployed on the actual mechanical arm when the target multilayer perceptron model meets a preset condition.

After the target multilayer perceptron model is deployed on the actual mechanical arm and when a new data set collected by the actual mechanical arm is acquired, the target multilayer perceptron model is fine-tuned based on the data set.

During training, forward propagation, loss calculation, backpropagation, and parameter update are repeatedly performed until the model converges or a preset number of iterations is reached. In addition, during the training, it is necessary to constantly verify the performance of the model and observe the training process. After deployment, the model is continuously iteratively optimized based on transfer learning, which is characterized in that after the deployment, data is further collected, and on this basis, transfer learning is performed, so that the model is continuously iterated. Finally, real-time synchronization can be implemented without real-time data transmission.

If a training result is satisfactory, the neural network will be deployed in a mechanical arm of a factory or a laboratory. By further collecting data and training the data, the model can be continuously iterated and optimized. The goal is that real-time synchronization can still be implemented between the actual mechanical arm and the virtual mechanical arm during motion even if there is no real-time data transmission.

To facilitate better implementation of the method for virtual-reality synchronization mapping of a mechanical arm according to the embodiment of the present application, an embodiment of the present application further provides an apparatus for digital twin virtual-reality synchronization mapping of a mechanical arm based on the aforementioned method for digital twin virtual-reality synchronization mapping of a mechanical arm. Meanings of nouns are the same as those in the aforementioned method for digital twin virtual-reality synchronization mapping of a mechanical arm. For specific implementation details, reference may be made to the description in the above-mentioned method embodiment.

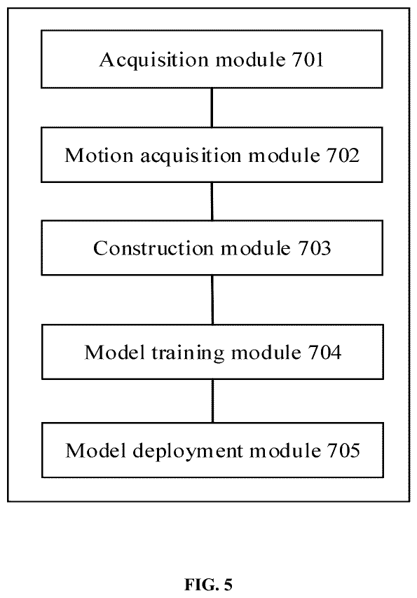

FIG. 5 is a schematic structural diagram of an apparatus for digital twin virtual-reality synchronization mapping of a mechanical arm according to an embodiment of the present application. The apparatus for digital twin virtual-reality synchronization mapping of a mechanical arm may include an acquisition module 701, a motion acquisition module 702, a construction module 703, a model training module 704, and a model deployment module 705, where
the acquisition module 701 is configured to acquire a virtual mechanical arm model built based on an actual mechanical arm in a virtual environment, where the virtual mechanical arm model is configured to map the actual mechanical arm;
the motion acquisition module 702 is configured to acquire real motion information collected when the actual mechanical arm moves;
the construction module 703 is configured to construct a training set and a test set based on the real motion information;
the model training module 704 is configured to train a target multilayer perceptron model based on the training set, and test the target multilayer perceptron model based on the test set, where the target multilayer perceptron model is configured to predict a motion of the virtual mechanical arm model in the virtual environment; and
the model deployment module 705 is configured to deploy the target multilayer perceptron model on the actual mechanical arm when the target multilayer perceptron model meets a preset condition.

An embodiment of the present application further provides an electronic device, including a memory and a processor, where the processor is configured to perform, by invoking a computer program stored in the memory, the steps in the method for digital twin virtual-reality synchronization mapping of a mechanical arm according to this embodiment or steps in a method for digital twin virtual-reality synchronization mapping of a mechanical arm.

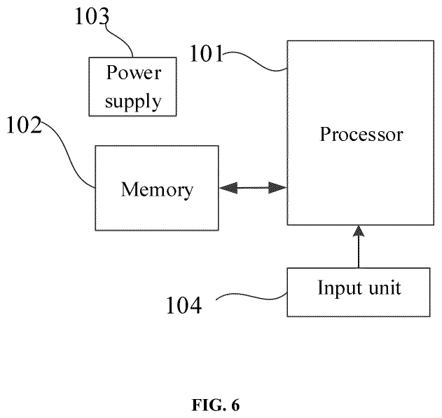

FIG. 6 is a schematic structural diagram of an electronic device according to an embodiment of the present application.

The electronic device may include a processor 101 with one or more processing cores, a memory 102 with one or more computer-readable storage media, a power supply 103, an input unit 104, and other components. It can be understood by those skilled in the art that the structure of the electronic device shown in the figure does not constitute a limitation on the electronic device, and may include more or fewer components than those shown, or combine some components, or have different component arrangements.

Specifically, the processor 101 is a control center of the electronic device, connects all parts of the whole electronic device by using various interfaces and lines, and executes various functions and processing data of the electronic device by running or executing software programs and/or modules stored in the memory 102 and invoking data stored in the memory 102. Optionally, the processor 101 may include one or more processing cores. Optionally, the processor 101 may integrate an application processor and a modulation and demodulation processor, where the application processor is mainly configured to handle an operating system, a user interface, an application program, and the like, and the modulation and demodulation processor is mainly configured to handle wireless communication. It can be understood that the above modulation and demodulation processor may not be integrated into the processor 101.

The memory 102 may be configured to store software programs and modules, and the processor 101 executes various functional applications and data processing by running the software programs and the modules stored in the memory 102. The memory 102 may mainly include a program storage area and a data storage area. The program storage area may store an operating system, an application program required by at least one function (such as a sound playing function and an image playing function), and the like. The data storage area may store data created based on use of the electronic device, and the like. In addition, the memory 102 may include a high-speed random access memory, and may further include a nonvolatile memory, for example, at least one disk storage device, a flash memory device, or another nonvolatile solid-state storage device. Correspondingly, the memory 102 may further include a memory controller, to provide access to the memory 102 by the processor 101.

The electronic device further includes a power supply 103 for supplying power to various components. Optionally, the power supply 103 may be logically connected to the processor 101 by means of a power management system, so as to achieve charging, discharging, power consumption management, and other functions by means of the power management system. The power supply 103 may further include one or more direct current or alternating current power supplies, a recharging system, a power failure detection circuit, a power converter or inverter, a power status indicator, and other arbitrary components.

The electronic device may further include an input unit 104, and the input unit 104 may be configured to receive input digital or character information and generate keyboard, mouse, joystick, optical or trackball signal inputs related to user settings and function control.

Although not shown, the electronic device may further include a display unit, an image acquisition component, and the like, which is not described in detail herein. Specifically, in this embodiment, the processor 101 in the electronic device loads executable code corresponding to one or more computer programs into the memory 102 according to the following instructions, and the processor 101 performs the steps in the method for digital twin virtual-reality synchronization mapping of a mechanical arm according to the present application, for example:
a virtual mechanical arm model built based on an actual mechanical arm in a virtual environment is acquired, where the virtual mechanical arm model is configured to map the actual mechanical arm; real motion information collected when the actual mechanical arm moves is acquired; a training set and a test set are constructed based on the real motion information; a target multilayer perceptron model is trained based on the training set, and the target multilayer perceptron model is tested based on the test set, where the target multilayer perceptron model is configured to predict a motion of the virtual mechanical arm model in the virtual environment; and the target multilayer perceptron model is deployed on the actual mechanical arm when the target multilayer perceptron model meets a preset condition.

It should be noted that the electronic device according to the embodiment of the present application belongs to the same concept as the method for digital twin virtual-reality synchronization mapping of a mechanical arm in the above embodiment. For details of the specific implementation process, reference may be made to the above related embodiments, and details are not described herein.

The present application further provides a computer-readable storage medium on which a computer program is stored. When the computer program stored thereon is executed on the processor of the electronic device according to the embodiment of the present application, the processor of the electronic device is caused to perform the steps in the method for digital twin virtual-reality synchronization mapping of a mechanical arm according to the present application. The storage medium may be a magnetic disk, an optical disc, a read-only memory (ROM), a random access memory (RAM), or the like.

The present application further provides a computer program product or a computer program. The computer program product or the computer program includes computer instructions, and the computer instructions are stored in a computer-readable storage medium. A processor of a computer device reads the computer instructions from the computer-readable storage medium, and the processor executes the computer instructions to enable the computer device to perform various optional implementations of the method for digital twin virtual-reality synchronization mapping of a mechanical arm described above.

The method and apparatus for digital twin virtual-reality synchronization mapping of a mechanical arm according to the present application are described above in detail. Specific examples are used herein for illustration of the principles and implementations of the present application. The description of the above embodiments is used only to help understand the method and its core ideas according to the present application. In addition, those skilled in the art may make changes in terms of specific implementations and scope of application in accordance with the ideas of the present application. In conclusion, the content of this specification shall not be construed as a limitation to the present application.

It should be noted that when the above embodiments of the present application are applied to specific products or technologies, a user's permission or consent is required for relevant data involving the user, and the collection, use and processing of the relevant data need to comply with relevant laws, regulations and standards of relevant regions.

What is claimed is:

1. A method for digital twin virtual-reality synchronization mapping of a mechanical arm, comprising:
acquiring a virtual mechanical arm model built based on an actual mechanical arm in a virtual environment, wherein the virtual mechanical arm model is configured to map the actual mechanical arm;
acquiring real motion information collected when the actual mechanical arm moves;
constructing a training set and a test set based on the real motion information;
training a target multilayer perceptron model based on the training set, and testing the target multilayer perceptron model based on the test set, wherein the target multilayer perceptron model is configured to predict a motion of the virtual mechanical arm model in the virtual environment; and
deploying the target multilayer perceptron model on the actual mechanical arm when the target multilayer perceptron model meets a preset condition.

2. The method according to claim 1, wherein the acquiring a virtual mechanical arm model built based on an actual mechanical arm in a virtual environment comprises:
acquiring an initial mechanical arm model obtained by mapping and modeling the actual mechanical arm;
setting an origin of the initial mechanical arm model and adjusting a local coordinate system; and
assembling the initial mechanical arm model based on a preset component set and a preset parent-child relationship to obtain the virtual mechanical arm model.

3. The method according to claim 1, wherein the real motion information comprises a real initial angle, a real current angle, and a real target angle, and the method for digital twin virtual-reality synchronization mapping of a mechanical arm comprises:
acquiring the real motion information of the actual mechanical arm during motion that is collected by a sensor according to a preset period; and
storing the real motion information in a preset database.

4. The method according to claim 3, wherein the real motion information comprises a plurality of pieces of sub-motion information, the sub-motion information comprises a real initial angle, a real current angle, and a real target angle, and the constructing a training set and a test set based on the real motion information comprises:
placing the plurality of pieces of sub-motion information in the real motion information into two sets to obtain the training set and the test set, wherein a quantity ratio of the sub-motion information in the training set and the test set is a preset ratio.

5. The method according to claim 4, wherein the preset condition comprises at least one of the following: a target loss value is less than a preset loss value and a number of iterations reaches a preset number of times, and
the training a target multilayer perceptron model based on the training set, and testing the target multilayer perceptron model based on the test set comprises:
inputting a real initial angle, a real target angle, and a number of steps in the training set into the target multilayer perceptron model to obtain a model-predicted angle;
calculating the target loss value base on the model-predicted angle and a corresponding real current angle by using a preset loss function; and
iteratively updating the target multilayer perceptron model until the target loss value is less than the preset loss value or the number of iterations reaches the preset number of times.

6. The method according to claim 5, wherein the target multilayer perceptron model comprises an input layer, a hidden layer, and an output layer, the input layer is configured to normalize data, and the output layer is configured to output a group of vectors, which is linearly mapped to the model-predicted angle of the mechanical arm.

7. The method according to claim 5, wherein the preset condition comprises that a model performance index meets a preset index condition, and the training a target multilayer perceptron model based on the training set, and testing the target multilayer perceptron model based on the test set comprises:
testing, when the target loss value is less than the preset loss value or the number of iterations reaches the preset number of times, the target multilayer perceptron model based on the test set to obtain the model performance index of the target multilayer perceptron model on the test set.

8. The method according to claim 7, wherein the iteratively updating the target multilayer perceptron model until the target loss value is less than the preset loss value or the number of iterations reaches the preset number of times comprises:
calculating a gradient parameter of the target loss value relative to a current model parameter of the target multilayer perceptron model;
updating the current model parameter of the target multilayer perceptron model based on the gradient parameter and a preset learning rate to obtain an updated target multilayer perceptron model; and
determining a new target loss value based on the updated target multilayer perceptron model and recording a number of iterations once.

9. The method according to claim 1, further comprising:
after the target multilayer perceptron model is deployed on the actual mechanical arm and when a new data set collected by the actual mechanical arm is acquired, fine-tuning the target multilayer perceptron model based on the data set.

10. The method according to claim 1, wherein the virtual mechanical arm model controls a motion via a control script, and the control script is controlled by means of a quaternion or a process identifier (PID) controller.

11. The method according to claim 3, wherein the acquiring the real motion information of the actual mechanical arm during motion that is collected by a sensor according to a preset period comprises:
communicating via a socket interface to acquire the real motion information of the actual mechanical arm during motion that is collected by the sensor according to the preset period.

12. An apparatus for digital twin virtual-reality synchronization mapping of a mechanical arm, comprising:
an acquisition module, configured to acquire a virtual mechanical arm model built based on an actual mechanical arm in a virtual environment, wherein the virtual mechanical arm model is configured to map the actual mechanical arm;
a motion acquisition module, configured to acquire real motion information collected when the actual mechanical arm moves;
a construction module, configured to construct a training set and a test set based on the real motion information;
a model training module, configured to train a target multilayer perceptron model based on the training set, and test the target multilayer perceptron model based on the test set, wherein the target multilayer perceptron model is configured to predict a motion of the virtual mechanical arm model in the virtual environment; and
a model deployment module, configured to deploy the target multilayer perceptron model on the actual mechanical arm when the target multilayer perceptron model meets a preset condition.
